(19) United States
(12) Patent Application Publication
(10) Pub. No.: US 2017/0206506 A1
(43) Pub. Date: Jul. 20, 2017

(54) Method of Booking a Personal Training Session

(71) Applicant: Matthew McKinnis, Alexandria, VA (US)

(72) Inventor: Matthew McKinnis, Alexandria, VA (US)

(21) Appl. No.: 15/407,978

(22) Filed: Jan. 17, 2017

Related U.S. Application Data
(60) Provisional application No. 62/279,041, filed on Jan. 15, 2016.

(51) Int. Cl. G06Q 10/10; G06Q 20/10; G06Q 30/06

(52) U.S. Cl. CPC G06Q 10/1095; G06Q 30/0625; G06Q 20/10

(57) ABSTRACT

A method of booking a personal training session is executed between a user account and a plurality of trainer accounts that are managed by a remote server. The user account first uploads a trainer request for a personal trainer session, wherein the trainer request includes a set of trainer-search parameters. The remote server then identifies a plurality of matching trainer account from the trainer accounts according to the set of trainer-search parameters. Then, a specific trainer account from the matching trainer accounts accepts the trainer request enabling the remote server to notifies the user account. The personal training session is then conducted between the user account and the specific trainer account. The remote server then executes a payment process between the user and the specific trainer account so that the user account makes a session payment and the specific trainer account receives a session payout for the personal training session.

The current application claims a priority to the U.S. Provisional Patent application Ser. No. 62/279,041 filed on Jan. 15, 2016. The current application is filed on Jan. 17, 2017 while Jan. 15, 2017 was on a weekend and Jan. 16, 2017 was a holiday.

### FIELD OF THE INVENTION

The present invention relates generally to the mobile application. More specifically, the present invention provides an efficient and on-demand method of booking a personal training session between a trainee and a trainer.

### BACKGROUND OF THE INVENTION

Personal fitness has become an important aspect in an individual's everyday life. Gyms, indoor recreations, and other fitness facilities seem to be a regular visit for many people whether it is to better their physical capabilities or to simply maintain a healthy lifestyle. Many tools have been created to better assist individuals in monitoring and quantifying their fitness progress. However, despite the many tools and new exercise equipment, the desire for human interaction still exists and is needed. Whether it is a class setting, a group activity, a personal trainer session, or even a gym partner, individuals seem to thrive in their personal fitness when human interaction is involved.

It is an objective of the present invention to provide a method of booking a personal training session. More specifically, the present invention serves to facilitate communication between a trainee and a trainer so that the trainee is easily able to book a qualified trainer for their selective workout sessions. The present invention includes a registration process that involves with creating a user profile and a payment process. The present invention then executes the overall process, wherein the trainee is able to select a qualified trainer for their workout session depending on their preferences. In other words, the trainee has the ability to select the qualified trainer according to type of training, date, location, and time. The present invention also verifies the services that the trainer provides and facilitates the payment process between the trainee and the trainer.

### BRIEF DESCRIPTION OF THE DRAWINGS

FIG. 1 is a flow chart illustrating the overall process of the present invention.

FIG. 2 is a flow chart illustrating the workout-performance progress report within the overall process of the present invention.

FIG. 3 is a flow chart illustrating the workout-evaluation progress report within the overall process of the present invention.

FIG. 4 is a flow chart illustrating the user account within the overall process of the present invention.

FIG. 5 is a flow chart illustrating the trainer account within the overall process of the present invention.

FIG. 6 is a flow chart illustrating the identifying of the matching trainer accounts within the overall process of the present invention.

FIG. 7 is a flow chart illustrating the accept or deny status of the acceptance confirmation within the overall process of the present invention.

FIG. 8 is a flow chart illustrating the payment process between the user account and the trainer account within the overall process of the present invention.

### DETAIL DESCRIPTIONS OF THE INVENTION

All illustrations of the drawings are for the purpose of describing selected versions of the present invention and are not intended to limit the scope of the present invention.

The present invention is a method of booking a personal training session between a user, trainee, and a trainer. The present invention is preferably designed as a mobile application or a web application so that the present invention is able to remotely execute the booking process between the client and the trainer.

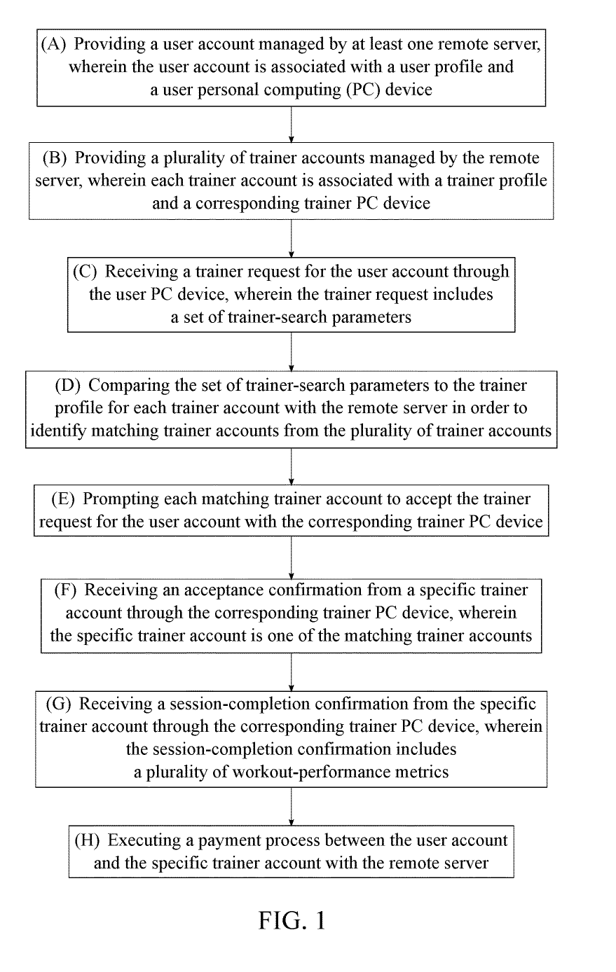

The system that executes the method of the present invention includes at least one remote server, a user account, and a plurality of trainer accounts as shown in FIG. 1. The user account and the plurality of trainer accounts are created on the present invention as both types of accounts can interact with each other to complete the overall process of the present invention. The remote server, which manages the interaction between the user account and the plurality of trainer accounts, executes some internal processes of the present invention. More specifically, an individual who requires personal training sessions creates the user account through a user personal computing (PC) device so that the user account can subscribe to the present invention. The remote server is then able to identify the individual who requires personal training session as the user account, and, thus the remote server manages the user account. An individual who provides personal training sessions creates each trainer account through a corresponding trainer PC device so that each trainer account can subscribe to the present invention. The remote server is then able to identify the individuals who provides personal training session as the plurality of trainer accounts, and, thus the remote server manages the plurality of trainer accounts.

In reference to FIG. 1, the user account includes a user profile, wherein the user profile is required to complete before accessing the overall process of the present invention. More specifically, the remote server prompts the user to upload basic user information, an email address, a username, and a password to sign-up for the present invention. upon successful submission of the basic user information and the email address, the remote server then sends a confirmation email to the registered email address. The user can then access the present invention through the confirmation email to set up a username and a password thus completing the sign-up process. Additionally, the present invention also enables the user to recover and reset the username and/or the password through the registered email address if the existing username and/or the password are forgotten. Once the sign-up process is completed, the user can simply enter the username and the password to access the present invention.

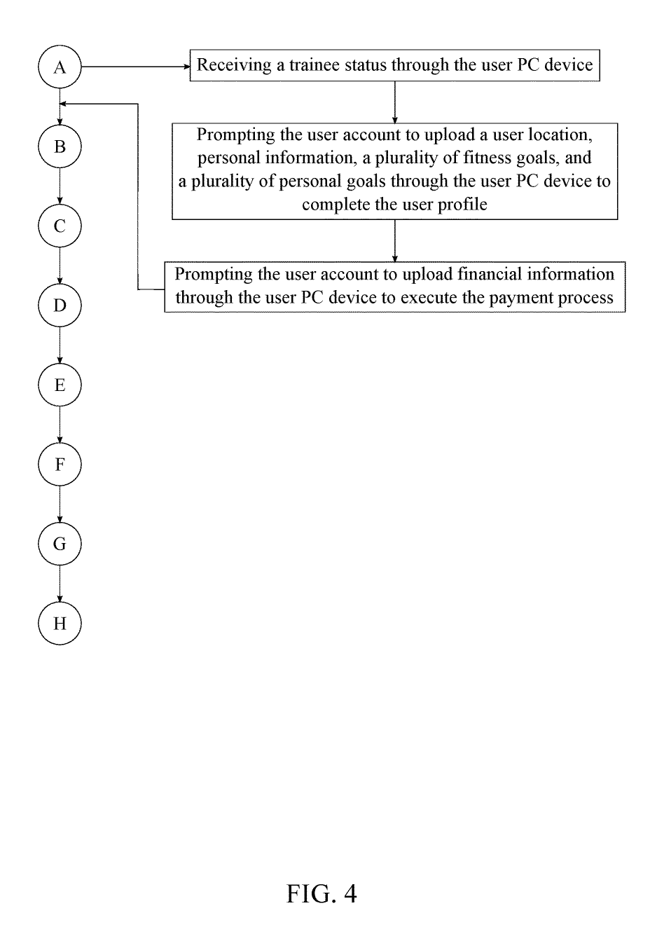

In reference to FIG. 1 and FIG. 4, when the present invention is accessed by a user who is also a trainee, the trainee first needs to submit a trainee status through the user PC device so that the remote server can identify that the applicant is the user account. After the applicant is identified as the user account, he remote server prompts the user account to sign a waiver agreement that explains terms and conditions of the present invention in relation to the user account. The remote server then prompts the user account to upload a user location, personal information, a plurality of fitness goals, and a plurality of personal goals through the user PC device. The personal information includes a profile picture, a first name, a middle name, a last name, a material status, a date of birth, a primary contact number, specific trainer requests, physical limitations, an email address, body measurements, body fat, body weight, and body height. If the basic user information includes some of the above mentioned personal information, the user account may not have to re-enter them as they are preferably autofill from the sign-up process. The fitness goals can include, but is not limited, a desired weight target, desired body measurements, a desired body fat, and desired exercise repetitions. The personal goals can include, but is not limited to, desire to complete a physical activity such as a marathon, desire to join a sports team such as a football team, and desire to complete certain exercises. The remote server also prompts the user account to upload financial information through the user PC device so that the present invention is able to execute a payment process from the user account and one of the plurality of trainer accounts in the event of booking a personal training session. The financial information for the user account can include, but is not limited to, a billing name, a billing address, and a bank account number or debit card number or credit card number so that the user account is able to transfer money to one of the plurality of trainer account that conducts the personal training session.

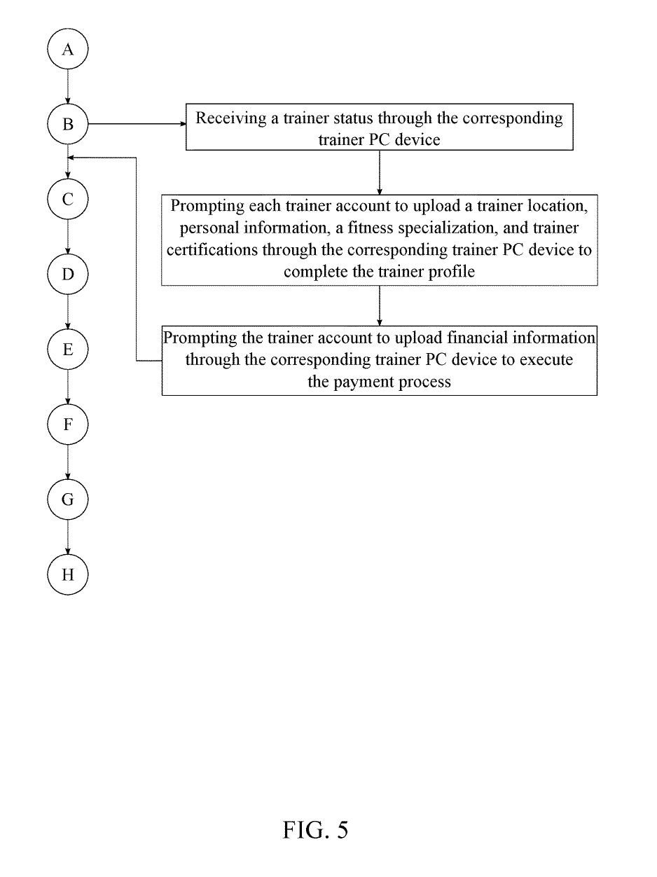

In reference to FIG. 1 and FIG. 5, when the present invention is accessed by a user who is also a trainer, the trainer first needs to submit a trainer status through the corresponding trainer PC device so that the remote server can identify that the applicant is the trainer account. After the applicant is identified as the trainer account, he remote server prompts the trainer account to sign a waiver agreement that explains terms and conditions of the present invention in relation to the trainer account. The remote server then prompts the trainer account to upload a trainer location, personal information, a fitness specialization, and trainer certifications through the corresponding trainer PC device. The personal information includes a profile picture, a first name, a middle name, a last name, a material status, a date of birth, a primary contact number, and an email address. If the basic user information includes some of the above mentioned personal information, the trainer account may not have to re-enter them as they are preferably autofill from the sign-up process. The fitness specialization can include, but is not limited, a corrective exercise specialization, a performance enhancing specialization, a behavior specialization, a fitness nutrition specialization, a group training specialization, a weight loss specialization, a woman fitness specialization, a men fitness specialization, a youth fitness specialization, a senior fitness specialization, and a sport specialization. The trainer certifications may include a degree, a CPR/AED certification, specialized certifications, and insurance. Once the trainer location, the personal information, the fitness specialization, and the trainer certifications are uploaded to the remote server, a background check is conducted for the trainer account to authenticate and confirm the trainer account. The background check can be conducted offline to the present invention or can be conducted through the remote server to expedite the confirmation process of the trainer account. The remote server also prompts the trainer account to upload financial information through the corresponding trainer PC device so that the present invention is able to execute the payment process from the user account to the trainer account in the event of completing a personal training session. The financial information for the trainer account can include, but is not limited to, a billing name, a billing address, and a bank account number or debit card number or credit card number so that the trainer account that conducts the personal training session is able to receive money from the user account.

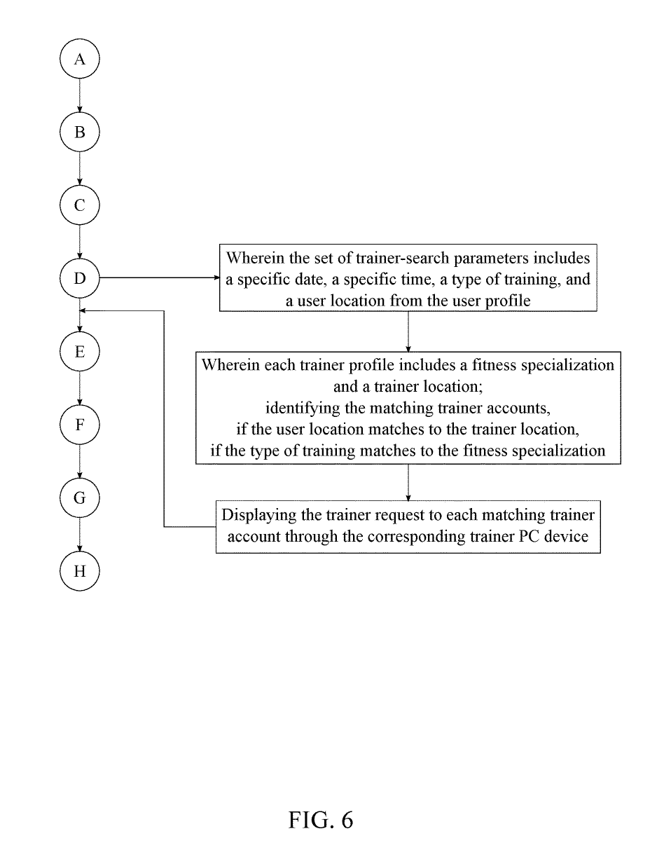

In order to execute the overall process of the present invention as shown in FIG. 1 and FIG. 6, the user account first need to send out a trainer request in order to book a personal training session so that the remote server can locate the plurality of trainer accounts according to the requirements of the user account. The remote server then compare the set of trainer-search parameters to the trainer profile for each trainer account in order to identify matching trainer accounts from the plurality of trainer account. More specifically, the set of trainer-search parameters includes a specific date, a specific time, a type of training, and a user location. Then, the remote server identifies the matching trainer accounts if the user location matches to the trainer location and the type of training of the user account matches to the fitness specialization of the trainer account. The trainer request is then displayed to each matching trainer account through the corresponding trainer PC device so that each matching trainer account can be prompted to accept the trainer request for the user account with the corresponding trainer PC device. In other words, the remote server sends out a notification to each matching trainer account thus explaining the specific date, the specific time, the type of training, and the user allocation of the trainer request. Each matching trainer account is then able to accept or deny the trainer request based upon their availability. When a specific trainer account from the matching trainer account accepts the trainer request, the remote server receives an acceptance confirmation from the specific trainer account through the corresponding trainer PC device. As a result, the trainer request becomes unavailable to the remaining matching trainer accounts in order to prevent double booking for the trainer request.

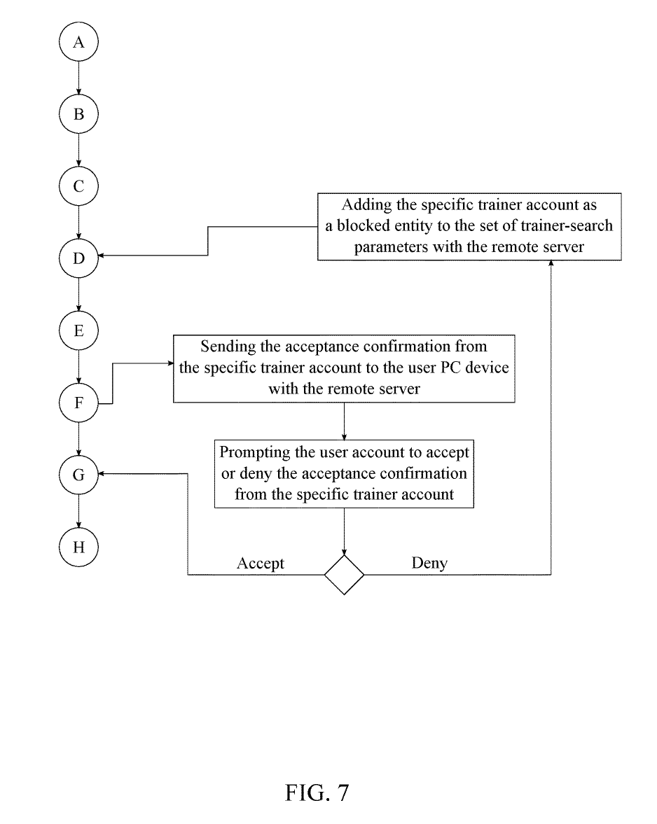

In reference to FIG. 1 and FIG. 7, the remote server sends a notification to the user account stating that the specific trainer account accepts the trainer request. More specifically, the remote server sends the acceptance confirmation from the specific trainer account to the user PC device and prompts the user account to accept or deny the acceptance confirmation from the specific trainer account. Additionally, the user account can view the trainer profile to make sure that the specific trainer account is appropriate for the set of trainer-search parameters and personal preference of the user account. If additional information requires to be discussed between the user account and the specific trainer account, the present invention allows a private messaging platform for both the user account and the specific trainer account to further confirm details regarding the personal training session. If the user account accepts the acceptance confirmation from the specific trainer account, the remote server continues the overall process of the present invention can proceeds into the succeeding step of the overall process. However, if the user account denies the acceptance confirmation from the specific trainer account, the remote server adds the specific trainer account as a blocked entity to the set of trainer-search parameters and re-identifies the matching trainer accounts from the plurality of trainer accounts so that the user account can receive a different acceptance confirmation.

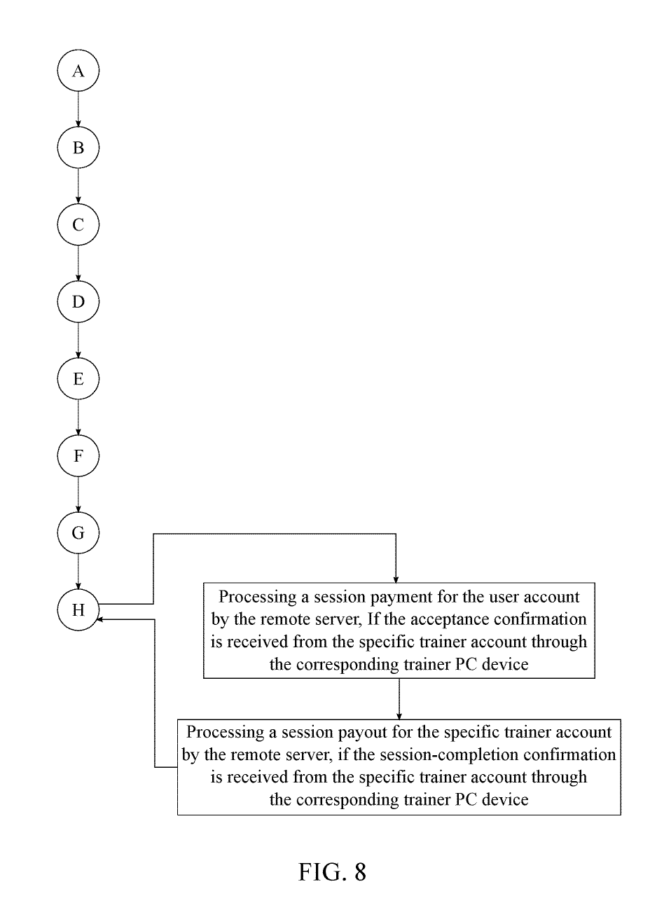

In reference to FIG. 1 and FIG. 8, after the personal training session is completed between the user account and the specific trainer account, the remote server receives a session-completion confirmation from the specific trainer account through the corresponding trainer PC device. The session-completion confirmation includes a plurality of workout-performance metrics such as, types of performed exercises, reps and sets of performed exercises, time duration for performed exercises, total workout time, personal comments, and any other related metrics. The remote server then executes the payment process between the user account and the specific trainer account. More specifically, the remote server processes a session payment for the user account when the acceptance confirmation is received from the specific trainer account through the corresponding trainer PC device thus withdrawing the money from the user account. The remote server processes a session payout for the specific trainer account when the session-completion confirmation is received from the specific trainer account through the corresponding trainer PC device thus crediting the money to the specific trainer account. Additionally, the session payout amount is less than the session payment amount as a predetermined percentage of the session payment is withheld for profitability and operational cost of the present invention.

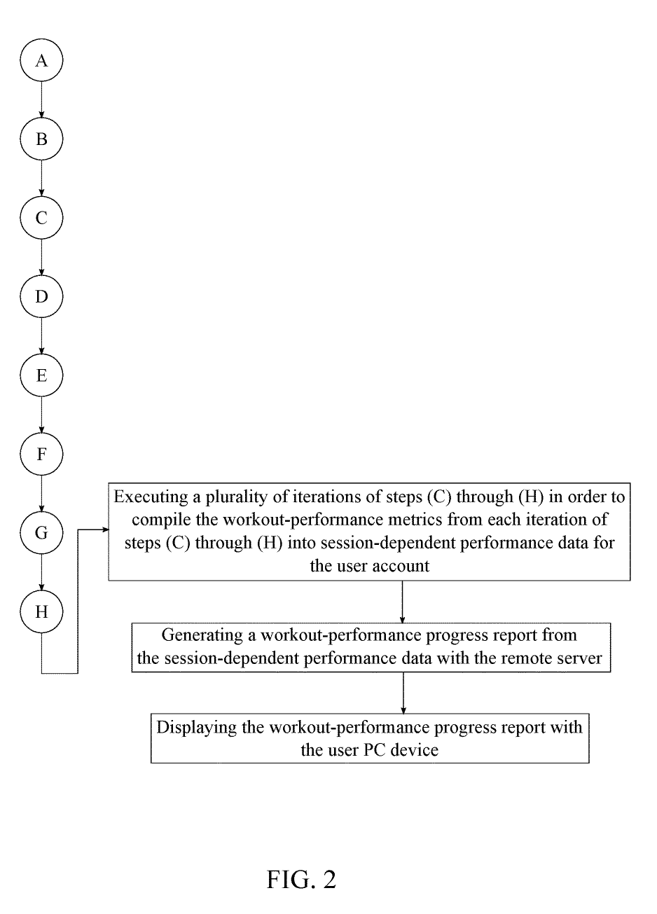

In reference to FIG. 2, the remote server compiles the workout-performance metrics from a plurality of iterations of the overall process into session-dependent performance data for the user account. The session-dependent performance data is utilized to generates a workout-performance progress report with the remote server. The workout-performance progress report illustrates an overall progress view for the personal training sessions from the perspective view of the specific trainer account and is displayed to the user account through the user PC device.

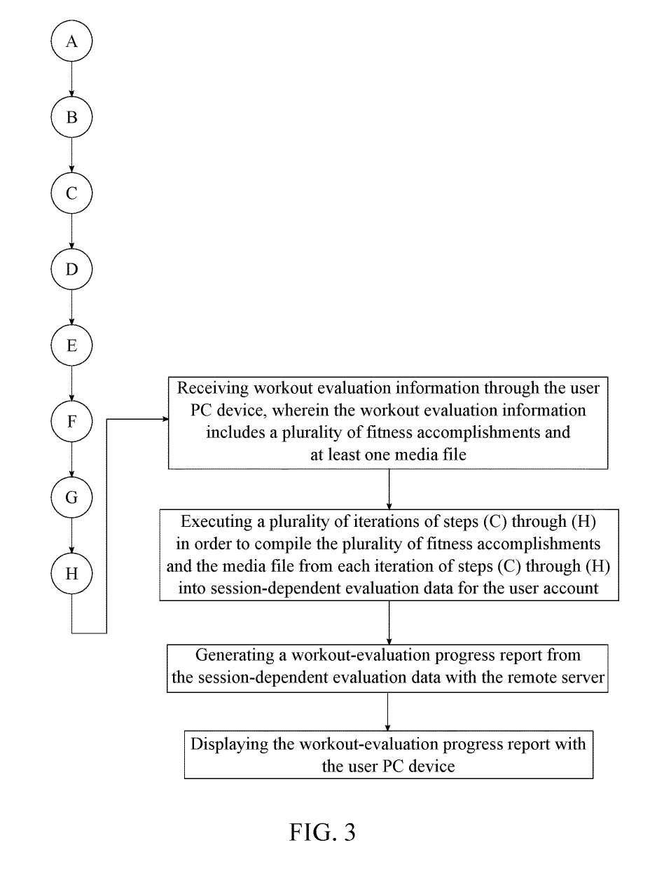

In reference to FIG. 3, the remote server receives workout evaluation information through the user PC device as the workout evaluation information includes a plurality of fitness accomplishments and at least one media file. The remote server then compiles the plurality of fitness accomplishments and the media file from a plurality of iterations of the overall process into session-dependent evaluation data for the user account. The session-dependent evaluation data is utilized to generate a workout-evaluation progress report with the remote server. The workout-evaluation progress report illustrates an overall progress view for the personal training sessions from the perspective view of the user account and is displayed to the user account through the user PC device.

An alternate option of the present invention may include a privacy feature that controls what is visible to the plurality of trainer accounts and the user account. More specifically, the privacy feature allows limited profile viewing to the plurality of trainer accounts or the user account, wherein the respective operator of each trainer account and the user account controls what is visible or not.

An alternate option of the present invention may include a variety of identification information requested through the sign-up process. Such identification information may include a code that corresponds to the trainee or trainer status of the client, a code that corresponds to a specific gym or training facility, and a code that corresponds to a variety of promotions of the present invention.

An alternate option of the present invention may include a feature that displays a plurality of links that directs the user account and each trainee account to different marketing applications. This feature synchronizes the information of the present application to that of a related application as the related applications may include fitness tracking applications, diet tracking application, and a variety of other fitness and health related applications.

An alternate option of the present invention may offer a rating feature to the user account. For example, once the user account completes a personal training session with the specific trainer account, the user account can rate the specific trainer account. This rating is publicly displayed to other user accounts as an evaluation feature.

Although the invention has been explained in relation to its preferred embodiment, it is to be understood that many other possible modifications and variations can be made without departing from the spirit and scope of the invention as hereinafter claimed.

What is claimed is:

1. A method of booking a personal training session comprises the steps of:
(A) providing a user account managed by at least one remote server, wherein the user account is associated with a user profile and a user personal computing (PC) device;
(B) providing a plurality of trainer accounts managed by the remote server, wherein each trainer account is associated with a trainer profile and a corresponding trainer PC device;
(C) receiving a trainer request for the user account through the user PC device, wherein the trainer request includes a set of trainer-search parameters;
(D) comparing the set of trainer-search parameters to the trainer profile for each trainer account with the remote server in order to identify matching trainer accounts from the plurality of trainer accounts;
(E) prompting each matching trainer account to accept the trainer request for the user account with the corresponding trainer PC device;
(F) receiving an acceptance confirmation from a specific trainer account through the corresponding trainer PC device, wherein the specific trainer account is one of the matching trainer accounts;
(G) receiving a session-completion confirmation from the specific trainer account through the corresponding trainer PC device, wherein the session-completion confirmation includes a plurality of workout-performance metrics; and
(H) executing a payment process between the user account and the specific trainer account with the remote server.

2. The method of booking a personal training session as claimed in claim 1 comprises the steps of:
executing a plurality of iterations of steps (C) through (H) in order to compile the workout-performance metrics from each iteration of steps (C) through (H) into session-dependent performance data for the user account;
generating a workout-performance progress report from the session-dependent performance data with the remote server; and
displaying the workout-performance progress report with the user PC device.

3. The method of booking a personal training session as claimed in claim 1 comprises the steps of:
receiving workout evaluation information through the user PC device, wherein the workout evaluation information includes a plurality of fitness accomplishments and at least one media file;
executing a plurality of iterations of steps (C) through (H) in order to compile the plurality of fitness accomplishments and the media file from each iteration of steps (C) through (H) into session-dependent evaluation data for the user account;
generating a workout-evaluation progress report from the session-dependent evaluation data with the remote server; and
displaying the workout-evaluation progress report with the user PC device.

4. The method of booking a personal training session as claimed in claim 1 comprises the steps of:
receiving a trainee status through the user PC device;
prompting the user account to upload a user location, personal information, a plurality of fitness goals, and a plurality of personal goals through the user PC device to complete the user profile; and
prompting the user account to upload financial information through the user PC device to execute the payment process.

5. The method of booking a personal training session as claimed in claim 1 comprises the steps of:
receiving a trainer status through the corresponding trainer PC device;
prompting each trainer account to upload a trainer location, personal information, a fitness specialization, and trainer certifications through the corresponding trainer PC device to complete the trainer profile; and
prompting the trainer account to upload financial information through the corresponding trainer PC device to execute the payment process.

6. The method of booking a personal training session as claimed in claim 1 comprises the steps of:
wherein the set of trainer-search parameters includes a specific date, a specific time, a type of training, and a user location from the user profile;
wherein each trainer profile includes a fitness specialization and a trainer location;
identifying the matching trainer accounts,
if the user location matches to the trainer location,
if the type of training matches to the fitness specialization; and
displaying the trainer request to each matching trainer account through the corresponding trainer PC device.

7. The method of booking a personal training session as claimed in claim 1 comprises the steps of:
sending the acceptance confirmation from the specific trainer account to the user PC device with the remote server;
prompting the user account to accept or deny the acceptance confirmation from the specific trainer account;
proceeding to step (G),
if the user account accepts the acceptance confirmation from the specific trainer account;
adding the specific trainer account as a blocked entity to the set of trainer-search parameters with the remote server; and
proceeding the step (D),
if the user account denies the acceptance confirmation from the specific trainer account.

8. The method of booking a personal training session as claimed in claim 1 comprises the step of:
prompting the trainer account to upload the plurality of workout-performance metrics, wherein the plurality of workout-performance metrics includes types of performed exercises, reps and sets of performed exercises, time duration for performed exercises, total workout time, and personal comments.

9. The method of booking a personal training session as claimed in claim 1 comprises the steps of:
processing a session payment for the user account by the remote server,
If the acceptance confirmation is received from the specific trainer account through the corresponding trainer PC device; and
processing a session payout for the specific trainer account by the remote server,
if the session-completion confirmation is received from the specific trainer account through the corresponding trainer PC device.
